(19) United States
(12) Patent Application Publication
(10) Pub. No.: US 2024/0100652 A1
(43) Pub. Date: Mar. 28, 2024

(54) PLASTIC BLASTING MEDIUM AND USE OF A PLASTIC BLASTING MEDIUM

(71) Applicant: DyeMansion GmbH, Planegg (DE)

(72) Inventors: Maximilian SPES, Gräfelfing (DE); Alexander ROSSMANN, München (DE); Philipp KRAMER, München (DE); Valentina MENNE, München (DE); Valentin GRABMAIER, Neuried (DE)

(21) Appl. No.: 18/274,588

(22) PCT Filed: Jan. 28, 2022
(86) PCT No.: PCT/EP2022/052110

§ 371 Date: Jul. 27, 2023

(30) Foreign Application Priority Data
Jan. 28, 2021 (DE) 10 2021 101 995.8

(51) Int. Cl. B24C 11/00; B29C 64/30; B33Y 40/20

(52) U.S. Cl. CPC B24C 11/005; B29C 64/30; B33Y 40/20

(57) ABSTRACT

The invention relates to a plastic blasting agent A and the use of a plastic blasting agent A, comprising at least one particle PA1 made from at least one polymer KA1 and at least one foreign particle FA1 for the surface treatment of a component that was created using additive manufacturing.

The invention relates to a plastic blasting agent A and the use of a plastic blasting agent A, comprising at least one particle PA1 made from at least one polymer KA1 and at least one foreign particle FA1 for the surface treatment of a component that was created by means of additive manufacturing.

Blasting agents are known from numerous industrial applications. The known blasting methods can be classified, among other things, with regard to the blasting agent used.

For example, blasting with conventional blasting agents refers to a blasting agent based on quartz sand (sandblasting), but other conventional blasting agents such as steel grit, chilled cast iron grit, wire shot and corundum are also common. These conventional blasting agents have the common property that the blasting agents are in a solid aggregate state under normal conditions. They usually have an abrasive effect. Blast treatment using conventional, abrasive blasting agents is usually accompanied by a large amount of dust (from the deflected blasting agents and the blasted material). This strong formation of dust is mostly undesirable. In addition, high costs arise due to the necessary disposal of the blasting agent contaminated with blasted material.

Correspondingly, blasting systems are therefore used to treat the surfaces of components. In this case, blasting material (sometimes also referred to as blasting medium or blasting agent) is blasted into a process chamber of the blasting system by means of one or more blasting nozzles or one or more blast wheels. The surface of the components is treated by the physical interaction of the particles of the blasting material with the surface of the components. For example, dirt or contaminants can be removed from the surface, porosity can be reduced, etc.

Components that have been produced in a powder bed, for example by means of an additive method such as laser melting, must be freed from the unfused particles of the powder bed after the production process. This process is referred to as depowdering in the field of additive manufacturing. A common method for depowdering of additively manufactured components is the blasting of the components with abrasive particles, which are accelerated by means of a medium such as air or water and remove the unfused powder particles from the component by hitting the component.

If the additively manufactured component has been gently freed from the powder, the rough, open-pored surface of the component comes to light. Depending on the application, there may be a need for further surface treatment. The original, untreated surface is not always desirable.

One possibility for further treatment of the surface is compaction blasting, also known as “shotpeening”. During this process, the initially open-pored surface of the additively manufactured component is compacted. The pores can be closed to a certain extent, the surface becomes smooth and shiny. In addition, the surface becomes more homogeneous. In order to achieve this effect, the components are also blasted by particles, which can optionally be accelerated by means of a medium such as air or water, or mechanically, for example by means of a blast wheel. The difference to the depowdering process described above is the selection of the particles that are accelerated. On the one hand, these should not be too abrasive, on the other hand, the particle shape should be appropriate in order to achieve the compaction effect.

The challenge in the depowdering process is not to damage the component or its surface, not to change the surface of the component in any way, or to remove particles that have already fused. The component must be processed so gently that subsequent processes, such as the compaction process, are not adversely affected.

Furthermore, ceramic beads or plastic beads are predominantly used in the prior art in the compaction process. They are also employed in pressure or injector blasting systems, in which the particles are accelerated using a medium such as air or water.

Glass beads, for example, i. e. glass particles with a spherical or drop-shaped grain shape, are therefore used as the preferred blasting agent in the depowdering process in the prior art. These glass beads are also employed in pressure or injector blasting systems, in which the particles are accelerated using a medium such as air or water.

Depending on the grain size and blasting pressure, the high mass of the glass particles usually employed can lead to damage on the component surface of additively manufactured components. This means that the glass particles are sometimes accelerated so much in the blasting process that particles that have already fused are removed from the surface, or fine geometries on the surface of the component break off or are damaged.

The blasting agents normally used for depowdering, such as “glass beads”, i. e. round or bead-shaped glass blasting agents, often have the undesirable side effect that the beads, due to their shape and mass, have a surface-changing effect when they hit the surface of the component—the surface is compacted. This effect is undesirable because the component should be freed from the residual powder without changing the surface if possible. In addition, the compaction of the surface causes light to be reflected, making the surface of the components shiny. The surface-changing effect should only take place in the subsequent compaction process, if desired.

In addition, with commonly used blasting agents based on metals or minerals, such as glass beads, broken glass or metal balls, during the depowdering process, due to acceleration and mechanical stress on the blasting agent particles in the blasting process, broken blasting agent or abrasion occurs, which settles on or in the surface of the additively manufactured plastic components. As a result, the surface is contaminated and damaged, and the material purity of the components is affected. Above all, this presents a problem in combination with subsequent surface treatment blasting processes, such as blasting the surface using round or bead-shaped blasting agents to compact the surface. This means that the broken blasting agent—or abrasion that settles on or in the surface of the components during the depowdering process—is shot even deeper into the surface due to the kinetic energy of the subsequently used compaction blasting beads and/or atomizes the dirt lying on the surface into even smaller components.

Impurities, changes and damage to the surface also mean that subsequent processing steps, such as surface treatment methods, coloring methods or coating methods, are adversely affected.

Contamination must be prevented, as this contamination leads to problems in further processing steps, such as coloring processes, infiltration processes, smoothing processes or coating processes, because the chemicals designed for coloring, infiltration, smoothing or coating of the additively manufactured components do not adhere to the unwanted particles on the surface or are not able to interact with them. Colorants, for example, are not able to color the unwanted particles on the surface. The application of paint or paint penetration is thus impeded, and the homogeneity and processing quality of the components is adversely affected. Furthermore, the compaction of the surface during the depowdering process must be avoided, since the paint penetration can be adversely affected.

In addition, the uncontrolled breaking of the blasting agents normally used means that the cleanliness of the blasting agent in the machine circuit is adversely affected. Due to the fact that broken pieces or abrasion are formed in different grain sizes during the process, material separators, such as inertial separators or screening devices, can no longer be optimally designed. So there are always unwanted particles in the blasting agent that is returned to the machine circuit.

Due to the different grain sizes that are used in the process of common blasting agents, there is also a need for more elaborate post-processing. The additively manufactured components have a wide variety of geometries in which blasting agent particles can get stuck. These particles then have to be removed manually after the blasting process. The greater the grain size variation in the blasting agent, the greater the likelihood that particles will get stuck in different geometries.

Another problem is the abrasiveness and aggressiveness of the blasting agents normally used. During the conveyance of the blasting agents through the blasting machines employed, the machine components are increasingly damaged.

In addition, there is another problem that results from the circumstances described above: In order to design the two processing steps, i.e. the depowdering process and the compaction process, to be of high quality, the processes usually have to be carried out on different systems. So there are usually two machines, each equipped with a blasting agent for depowdering or compaction.

As already described, glass beads are used in the depowdering process in the prior art, and ceramic beads are used in the compaction process, among other things.

There is therefore a need for an improved blasting agent for treating a component, which is preferably produced using additive manufacturing.

This object is achieved by the features of the independent claims. The features of the dependent claims define specific embodiments.

The invention therefore relates to a plastic blasting agent A, comprising at least one particle PA1 made from at least one polymer KA1 and at least one foreign particle FA1, the foreign particle FA1 not being an abrasive grain.

The invention also relates to the use of a plastic blasting agent A, comprising at least one particle PA1 made from at least one polymer KA1 and at least one foreign particle FA1 for the treatment of a component that was created by means of additive manufacturing.

A (plastic) blasting agent within the meaning of the present invention can comprise an agent comprising at least one type of particle, for example the particle PA1, during the blasting procedure, which can optionally be accelerated onto the object (component) to be treated by means of a medium, in particular a gas or mechanically by means of a blast wheel. In particular, a plastic blasting agent can be made at least partially from a plastic.

Abrasive grain within the meaning of the present invention can be understood to mean a particle that has the ability to grind and, in a blasting agent, has the task of polishing and cutting the workpiece. The abrasive grain is usually finely distributed in a base material, which comprises a raw material polymer and compounding agents.

A component within the meaning of the present invention can be a metal component, a ceramic component, a quartz component, a plastic component or a composite component. Plastic parts could be obtained, for example, by an injection molding process. It would also be conceivable to treat components, in particular plastic components, which were produced by a 3D printing process, for example a powder bed process, in the method according to the invention.

Within the meaning of the present invention, a particle can comprise an individual particle or a quantity of particles which are in particular of the same type.

The components, which are preferably produced in a powder-based manufacturing or printing process, can very particularly preferably be made from a material selected from the group consisting of polyamide, in particular polyamide 11 and polyamide 12, thermoplastic polyurethane, aluminum-filled polyamide, in particular aluminium-filled polyamide-12, glass-filled polyamide, carbon-reinforced polyamide, sand, gypsum, metal, composite material, thermoplastics, thermoplastic elastomers, polyolefins, polystyrenes, polyesters, polyimides and thermoplastic elastomers and combinations, blends or copolymers and filled variants (e.g. with glass, carbon fiber, aluminum) thereof.

The polymer KA1 in the plastic blasting agent A according to the invention preferably has a Shore hardness of 10 Shore A to 95 Shore D, particularly preferably 35 Shore A to 93 Shore D and very particularly preferably 70 Shore D to 93 Shore D.

The polymer KA1 in the plastic blasting agent A according to the invention is preferably selected from the group consisting of polyamides, resins, polyesters, polystyrenes, polyolefins, polyvinyls, rubbers, polyphenylenes, polyethers, polyurethanes, polysaccharides, polyimides, polyacrylates, silicones and blends and copolymers thereof, and the foreign particle FA1 is selected from the group consisting of metals, passivated metals, iron, steel, minerals, soot particles, carbon fibers, paint particles, ceramics, polymers, alloys or glasses. The polymer KA1 in the plastic blasting agent A according to the invention is particularly preferably selected from the group consisting of polyamides, polystyrenes, polyurethanes, polysaccharides, polyimides, polyacrylates, silicones and blends and copolymers, and the foreign particle FA1 is selected from the group consisting of ceramics or glasses.

Said KA1 is preferably selected in such a way that it has a glass transition temperature which is above the use temperature of the plastic blasting agent A. This has the advantage that all of the energy transferred to the blasting agent can be used to process the surface and part of the energy is not lost through the elastic deformation of the plastic blasting agent, as would be the case with elastic plastics. In a particular configuration of the invention, the glass transition temperature is above room temperature, i.e. >25° C. (according to DIN EN ISO 11357-2 by differential scanning calorimetry). Alternatively, in another configuration, the application temperature of the plastic blasting agent A can be reduced in order to also use polymers KA1 with glass transition temperatures below 25° C.

The invention also relates to the use of a plastic blasting agent A, comprising at least one particle PA1 made from at least one polymer KA1, and at least one foreign particle FA1 for the surface treatment of a component that was produced by additive manufacturing.

Furthermore, the invention preferably relates to the use of a plastic blasting agent A, wherein the component, which was created by means of additive manufacturing, was produced using a method selected from the group consisting of powder bed methods, light-curing methods or extrusion methods.

Furthermore, the invention preferably relates to the use of a plastic blasting agent A, wherein the component, which was created by means of additive manufacturing, was produced using a method selected from the group consisting of powder bed methods, such as (selective) laser sintering (SLS), binder jetting, multijet fusion technologies (MJF), highspeed sintering (HSS), cold metal fusion or laser melting methods; light-curing methods such as stereolithography (SLA or STL), digital light production (DLP), continuous light interface production (CLIP), PolyJet methods (PJM), DualCure methods, HotLithography and extrusion methods such as fused deposition modeling (FDM), fused filament Fabrication (FFF), MultiJet modeling (MJM), layer plastic Ddeposition, selective thermoplastic electrophotographic process (STEP).

An example of a powder-based manufacturing method (powder bed method) would be a selective laser sintering (SLS) method, in which the body of the plastic component is built up step by step. Other examples of powder bed methods include MJF, high speed sintering and binder jetting.

The foreign particles FA1 in the use according to the invention are preferably selected from the group consisting of minerals, soot particles, carbon fibers, color particles, ceramics, polymers, alloys or glasses, very particularly preferably glasses. Glass can be, for example, quartz glass, soda-lime glass, silicate glass, alkali-silicate glass, alumino-silicate glass, borosilicate glass and glass ceramics. Glass is generally understood to be compounds which have an SiO₂ content of at least 20%.

The foreign particle FA1 is preferably not of metallic origin.

In this case, in the use according to the invention of the plastic blasting agent A, the foreign particle FA1 is preferably not abrasive grain.

The polymer KA1 in the use of the plastic blasting agent A according to the invention is preferably selected from the group consisting of polyamides, resins, polyesters, polystyrenes, polyolefins, polyvinyls, rubbers, polyvinyl chlorides, polyphenylenes, polyethers, polyurethanes, polysaccharides, polyimides, polyacrylates, silicones and blends and copolymers thereof, and the foreign particle FA1 is selected from the group consisting of metals, passivated metals, iron, steel, minerals, soot particles, carbon fibers, paint particles, ceramics, polymers, alloys or glasses.

The polymer KA1 in the use of the plastic blasting agent A according to the invention is particularly preferably selected from the group consisting of polyamides, polystyrenes, polyurethanes, polysaccharides, polyimides, polyacrylates, silicones and blends and copolymers, and the foreign particle FA1 is selected from the group consisting of ceramics or glasses.

The filling of the plastic blasting agent A or the foreign particles FA1 in the plastic blasting agent A serve to increase the overall density of the individual particles PA1.

Therefore, the use of foreign particles FA1 with high densities is advantageous. In the use according to the invention, the density of the foreign particle FA1 is preferably in a range from 0.7 to 8 g/cm³, particularly preferably in the use according to the invention the density of the foreign particle FA1 is in a range from 2.5 to 8 g/cm³.

Particularly high densities can be achieved in particular with metals and alloys. Metallic foreign particles FA1 have the disadvantage that they generally produce metallic abrasion. Therefore, in one configuration of the invention, metallic or alloy foreign particles FA1 are used, which have a passivation layer. Within the meaning of the invention, the passivation layer can arise naturally or be produced in a targeted manner by technical methods. The oxide layer created during passivation can prevent or significantly reduce metallic abrasion.

In the use according to the invention, the density of the particle PA1 is preferably in a range from 0.7 to 8 g/cm³, particularly preferably in the use according to the invention the density of the particle PA1 is in a range from 1 to 6 g/cm³.

The use of plastic blasting agents, in particular polyamide 6, polyamide 11 or polyamide 12, has the advantage that 3D-printed components are not damaged during the blasting process due to the high elasticity of the particles PA1.

Due to the lower density of a plastic blasting agent without foreign particles, they have a lower mass compared to conventional (e.g. mineral) blasting agents. This means that plastic blasting agents of the same grain size have less kinetic energy than conventional blasting agents. Due to the higher specific weight that particles PA1 will have after being filled with foreign particles FA1, the kinetic energy of the particles, which are accelerated in the blasting process, is increased.

A foreign particle FA1 made of glass or ceramic is preferably used as the filling material, since these foreign particles have a relatively high density.

In particular, the specific weight of the individual particles PA1 should be increased. This is necessary in particular if a plastic blasting agent A is produced with a particularly small particle size, for example less than 500 μm.

The smaller the individual particles PA1 of the plastic blasting agent A, the less volume is available for the foreign particles FA1. Above all, the foreign particles FA1 should be enclosed as completely as possible by the plastic within the particle PA1. Thus, the quantity of foreign particles FA1 supplied cannot be increased arbitrarily, and the foreign particles FA1 should preferably have the greatest possible density.

The plastic blasting agent A can also wear out after a certain amount of blasting/operating time (rounding of the edges, gradual loss of material), even if it shows significantly less wear than conventional blasting agents. When filling, care is taken to ensure that the foreign particles FA1 are enclosed in plastic as completely as possible. If there is a loss of material on the individual particles PA1 after a certain period of use, the initially completely enclosed foreign particles FA1 can appear. These can then also become detached. As soon as the foreign particles FA1 become detached, they contaminate the plastic blasting agent A. The foreign particles FA1 can then be blasted into the surface of the (3D printed) components during the blasting procedure. The component and surface quality decreases. In addition, these foreign particles FA1 can impact subsequent processes. When the amount of foreign particles FA1 introduced into the particle PA1 is relatively large from the beginning, this process is accelerated. In addition, there is a higher risk from the start that foreign particles FA1 are not completely enclosed during the production process and become detached after a short period of use.

Therefore, if a certain amount of foreign particles FA1 within the plastic blasting agent A is exceeded, the stability of the plastic blasting agent A could be affected. If the proportion of foreign particles FA1 is too large, there is no longer enough encasing plastic material during production that reliably holds and binds the foreign particles FA1 together. This can lead to the individual particles PA1 breaking faster when they hit the surface of the component to be processed after the acceleration in the blasting process. This significantly accelerates the wear of the plastic blasting agent A. In addition, these foreign particles FA1 can then also become detached more quickly. As soon as the foreign particles FA1 become detached, they contaminate the plastic blasting agent A. The foreign particles FA1 can then be blasted into the surface of the (3D printed) components during the blasting process, which in turn leads to a decrease in component and surface quality.

In the use of the plastic blasting agent A according to the invention, the component is preferably produced in an additive manufacturing or printing process, wherein the component is produced from a material selected from the group consisting of polyamide, in particular polyamide 11 and polyamide 12, thermoplastic polyurethane, aluminum-filled polyamide, in particular aluminium-filled polyamide-12, glass-filled polyamide, carbon-reinforced polyamide, sand, gypsum, metal, composite material, thermoplastics, thermoplastic elastomers, polyolefins, polystyrenes, polyesters, polyimides and thermoplastic elastomers and combinations, blends or copolymers and filled variants (e.g. with glass, carbon fiber, aluminum) thereof.

In the use of plastic blasting agent A according to the invention, the component is very particularly preferably produced in an additive manufacturing or printing process, wherein the component is produced from a material selected from the group comprising metal, polyamide, in particular polyamide-11 and polyamide-12, thermoplastic polyurethane, aluminium-filled polyamide, in particular aluminium-filled polyamide-12, glass-filled polyamide, carbon-reinforced polyamide and combinations, blends or copolymers thereof.

In the use according to the invention, the plastic blasting agent A preferably comprises at least one particle PA1 made from at least one polymer KA1, and at least one foreign particle FA1, with additives and/or adhesion promoters possibly also being present. In the method according to the invention, the plastic blasting agent A very particularly preferably comprises at least one particle PA1 made from at least one polymer KA1, and at least one foreign particle FA1, with additives and/or adhesion promoters possibly also being present.

Additives lead, for example, to improved properties such as tensile strength, impact strength, antistatic effect or elongation at break. Additives may include thermal stabilizers, components to improve weather resistance, stabilizers, fillers, or other components known to those skilled in the art.

In contrast to mineral substances or metallic substances, a corresponding plastic blasting agent A is less abrasive, has a lower mass and has lower hardness, so that the flexibility of the plastic blasting agent A during the interaction with the materials of the machine components does not damage the component or a blasting system or components of a blasting system.

Due to the fact that the plastic blasting agent A employed is flexible and has a hardness similar to that of the blasted components, as well as by its low mass and thus lower kinetic energy in the depowdering process, damage to the surface is advantageously avoided.

Therefore, in the use of the plastic blasting agent A according to the invention, the treatment of the component preferably includes depowdering, compacting, smoothing and/or surface roughening.

Depowdering within the meaning of the present invention can mean that blasting material (sometimes also referred to as blasting medium or blasting agent) within the meaning of the present invention is blasted into a process chamber of the blasting system by means of one or more blasting nozzles or one or more blast wheels. The surface of the components is treated by the physical interaction of the particles of the blasting material with the surface of the components. Components that have been produced in a powder bed, for example by means of an additive method such as laser melting, can be freed from the unfused particles of the powder bed after the production process. This process is referred to as depowdering in the field of additive manufacturing.

Compacting within the meaning of the present invention can mean that blasting material (sometimes also referred to as blasting medium or blasting agent) within the meaning of the present invention is blasted into a process chamber of the blasting system by means of one or more blasting nozzles or one or more blast wheels. The surface of the components is treated by the physical interaction of the particles of the blasting material with the surface of the components. If the additively manufactured component has been gently freed from the powder, the rough, open-pored surface of the component comes to light. Depending on the application, there may be a need for further surface treatment. The original, untreated surface is not always desirable. In the compaction process within the meaning of the present invention, the initially open-pored surface of the additively manufactured component is compacted. The pores can be closed to a certain extent, the surface becomes smooth and shiny. In addition, the surface becomes more homogeneous. In order to achieve this effect, the components are also blasted by particles, which are accelerated by means of a medium such as air or water, or by mechanical movement, for example by a blast wheel. The difference to the depowdering process described above is the selection of the particles that are accelerated. On the one hand, these particles should not be too abrasive, on the other hand, the particle shape should be appropriate (spherical or almost spherical/not angular) in order to achieve the compaction effect.

Surface roughening within the meaning of the present invention can mean that blasting material (sometimes also referred to as blasting medium or blasting agent) within the meaning of the present invention is blasted into a process chamber of the blasting system by means of one or more blasting nozzles or one or more blast wheels. The surface of the components is treated by the physical interaction of the particles of the blasting material with the surface of the components. If the additively manufactured component (possibly after previous, other processing steps such as a (chemical) smoothing process or a compaction process) has a surface that is too smooth or too shiny, there may be a need for further surface treatment, depending on the application. A smooth, shiny surface is not always desired. In the case of surface roughening within the meaning of the present invention, the surface of the additively manufactured component is roughened using an accelerated blasting agent. The pores can thus be opened up to a certain extent, and the surface becomes rough, possibly dull and possibly open-pored. In order to achieve this effect, the components are also blasted by particles, which are accelerated by means of a medium such as air or water, or by mechanical movement, for example by a blast wheel. This process can also be employed to influence the haptic perception of the surface. The process can also be employed to prepare the surface (e.g. roughening the surface to ensure better adhesion of the paint or coating) according to the requirements of subsequent processes such as a painting or coating process.

Smoothing within the meaning of the present invention can mean that blasting material (sometimes also referred to as blasting medium or blasting agent) within the meaning of the present invention is blasted into a process chamber of the blasting system by means of one or more blasting nozzles or one or more blast wheels. The surface of the components is treated by the physical interaction of the particles of the blasting material with the surface of the components. If the additively manufactured component has been gently freed from the powder, the rough, open-pored surface of the component comes to light. Depending on the application, there may be a need for further surface treatment. The original, untreated surface is not always desirable.

In the smoothing process within the meaning of the present invention, the initially open-pored surface of the additively manufactured component is smoothened. This means that the elevations and depressions (or “hills and valleys”) visible on a microscopic level are adjusted to the surface structure. An attempt is made to reduce as much as possible the values Sdr (Developed Interface Ratio) and Sdq (Slope Square Value) used to define surface roughness (Sdr or Sdq=0 means completely flat surface). The surface will become smooth and possibly shiny. In order to achieve this effect, the components are also blasted by particles, which are accelerated by means of a medium such as air or water, or by mechanical movement, for example by a blast wheel.

One way of specifying the hardness of plastics is to determine the shore hardness. For example, if the Shore hardness of the component to be treated is known, the Shore hardness of the blasting agent can be adjusted accordingly.

In the use of the plastic blasting agent A according to invention the polymer KA1 preferably has a Shore hardness of 10 Shore A to 95 Shore D, particularly preferably 35 Shore A to 93 Shore D and very particularly preferably 70 Shore D to 93 Shore D.

In the use according to the invention, the plastic blasting agent A is preferably produced by a compounding process, an injection molding process, a precipitation polymerization process, an extrusion process or a coating process. In particular, the plastic blasting agent A can be obtained by one of the following steps:
1. Compounding, wherein plastic granules are mixed with a foreign particle FA1, preferably glass, to yield the plastic blasting agent A. If the proportion of foreign particles FA1 mixed in during the compounding process is too high, it is not possible to achieve a homogeneous mixture of plastic starting granules and foreign particles FA1. Thus, the proportion of foreign particles FA1 that are in the finished plastic blasting agent A can vary greatly within the blasting agent grains (particles PA1). A consistent density and quality of the blasting agent cannot be guaranteed.
2. Extrusion, wherein a mixture is heated in an extruder, plastic is extruded through a nozzle (e.g. 500 μm, depending on the desired strand width or grain size), and a plastic strand is formed. If the proportion of foreign articles FA1 mixed in is too high, strand breaks can occur during the extrusion process. The mixture of foreign particles FA1 and plastic granules previously produced in the compounding process is heated in an extruder and extruded as a plastic strand through a fine nozzle (diameter depends on the desired blasting agent grain size) to yield a plastic strand of the future plastic blasting agent A. The plastic blasting agent A is then produced from this plastic strand, which is stretched in later processing steps and then “cut up”. If there is too much air, moisture or foreign particles FA1 in the heated and extruded mass, strand breaks can occur. The continuous operation and throughput of the production plant is thus severely adversely affected.
3. Stretching, wherein a plastic strand of plastic is being stretched, i.e. increased in its length. A 400 μm plastic strand is preferably produced. From a technical point of view, there is a lower limit in the extrusion process as far as the nozzle diameter is concerned. The lower limit is also dependent on the size and number of foreign particles FA1 previously mixed in. This means that if a plastic blasting agent A is produced in the extrusion process in which foreign particles FA1 are mixed in, production problems can increase. Extruding a plastic strand with a smaller diameter than (e. g. 500 μm) causes technical problems due to the foreign particles FA1. Therefore, if necessary, use is made of the possibility of first extruding the plastic strand with a larger nozzle and then stretching it so that the plastic strand will have the desired, smaller diameter. This procedure can also lead to strand breaks if this has not already happened during the extrusion process. The higher the proportion of foreign particles FA1, the higher the probability that strand breaks and production difficulties will occur.
4. Granulation, wherein, for example, the plastic strand is divided into (400 μm×400 μm) particles.
5. Screening, wherein, for example, the granules are screened to remove incorrect grain sizes.

The plastic blasting agent A is preferably obtained by carrying out steps 1 to 5. Preferably, what is obtained after step 5 can be further reduced in size in a cryogenic milling process.

In the use according to the invention, a plastic blasting agent A is preferably employed, comprising at least one particle PA1 which consists of 3 to 95% by weight, preferably 50 to 90% by weight, of polymer KA1.

In the use according to the invention, a plastic blasting agent A is preferably employed, comprising at least one particle PA1 which contains 5 to 97% by weight, preferably 10 to 50% by weight, of at least one foreign particle FA1.

In the use according to the invention, a plastic blasting agent A is preferably employed, comprising at least one particle PA1 which contains 0 to 10% by weight, preferably 0 to 7% by weight, of at least one additive and/or one adhesion promoter.

A plastic blasting agent A is therefore preferably employed according to the invention, comprising at least one particle PA1 made of
−3 to 95% by weight, preferably 50 to 90% by weight, of at least one polymer KA1,
−5 to 97% by weight, preferably 10 to 50% by weight, of at least one foreign particle FA1, and
−0 to 10% by weight, preferably 0 to 7% by weight, of at least one additive and/or adhesion promoter.

The particle PA1 used in the use according to the invention is particularly preferably obtained by strand granulation, belt granulation, dry granulation, underwater granulation, cutting granulation or a milling process. As a result of the methods, the particle PA1 may be cylinder granules, cube granules, lens granules, chip granules, or polygonal granules. Polygonal granules can be obtained from a milling process. This type of processing allows the particles PA1 to have a polyhedral or cylindrical shape.

The foreign particles FA1 are preferably admixed in the compounding process, the injection molding process, the precipitation polymerization or the extrusion process.

The foreign particle FA1 particularly preferably contains at least one additive and/or one adhesion promoter in a concentration of 0.01 to 7% by weight.

The foreign particle FA1 is preferably enclosed by at least 90% of the polymer KA1 of the particle PA1. This has the advantage that contact between the foreign particle FA1 and the component is reduced to a minimum and the foreign particle FA1 does not cause any abrasive removal of material from the component and only the desired surface treatment (removal of powder, compacting, roughening and smoothing) takes place.

Therefore, the particle PA1 in the use according to the invention preferably has a polyhedral shape, for example a convex polyhedron, or a cylindrical shape. Within the meaning of the present invention, the shape of a polyhedron can also contain dents, i. e. the connecting line of two points of the polyhedron does not necessarily lie in the polyhedron. Another expression for a polyhedral shape or cylindrical shape can also be the term “angular” shape.

In a preferred embodiment, a polyhedral shape comprises a cubic or prismatic shape.

The particle PA1 in the use according to the invention therefore preferably has a cubic, cylindrical or prismatic shape.

By using the angular (e. g. cylindrical, cubic or prismatic) plastic blasting agent in the depowdering process, which preferably has a similar hardness as the additively manufactured plastic components, the risk of damaging the surface is reduced to a minimum. There is more flexibility in the selection of the grain size, and if desired, the blasting pressure can be increased. In addition, significantly finer structures or geometries can be processed.

The compaction of the surface is also advantageously completely avoided by using a plastic blasting agent A with an angular particle shape in the depowdering process. There is more flexibility in the selection of the grain size, the blasting pressure can be increased if desired, since the mass of the plastic particles is significantly lower compared to mineral blasting agents.

Due to the higher breaking strength of the particles PA1 and the fact that the polymer KA1 has a hardness similar to that of the additively manufactured components, advantageously no significant abrasion or breakage and therefore no contamination on the surface occurs when the particles PA1 are conveyed through the blasting systems, or by the impact of the particles PA1 on the surface of the additively manufactured components. This means there is more flexibility in the selection of the blasting pressure and the process time. In addition, complex material separators can be dispensed with. The plastic blasting agent A can also be used in the cycle for a significantly longer period of time without having to be replaced.

For material separators, the grain size and the mass of the particles that are to be separated are particularly important. Even if abrasion should occur, said abrasion differs in particle size/mass so much that the material separators are not affected.

Subsequent processing steps are not impaired by these described properties of the blasting agent used, in particular of the depowdering blasting agent.

The polyhedral or cylindrical particles PA1 employed in the depowdering process advantageously do not damage the machine components due to their nature. There is therefore no increased wear on machine parts, so that special protection of the machine is not necessary.

Likewise, there is preferably no change in the surface as a result of roughening or compacting, since the cubic, cylindrical or prismatic particles PA1 have a lower mass.

Due to the angular (polyhedral or cylindrical) shape, compaction effects do not occur. Because the particles PA1 are lighter than mineral blasting agents, there is less energy input to the surface.

In the use according to the invention, the particle PA1 with a cubic shape, the particle PA1 with a cylindrical shape or the particle PA1 with a prismatic shape preferably each independently have a grain size range in the range from 10 μm to 1000 μm. In the use according to the invention, the particle PA1 with a cubic shape particularly preferably has a grain size range in the range from 100 μm to 400 μm, very particularly preferably from 200 μm to 300 μm.

In the use according to the invention, the particle PA1 with a cylindrical shape preferably has a grain size range in the range from 100 μm to 800 μm, preferably from 200 μm to 700 μm.

In the use according to the invention, the particle PA1 with a cylindrical shape particularly preferably has a grain size range in the range from 100 μm to 400 μm, very particularly preferably from 200 μm to 300 μm.

In the use according to the invention, the particle PA1 with a prismatic shape preferably has a grain size range in the range from 100 μm to 400 μm, preferably from 200 μm to 300 μm.

Typically, an attempt is made to use the smallest possible grain size of the particles PA1 for the plastic blasting agent A employed. The smaller the particles employed, the lower the mass of the particles. The lower the mass of the particles, the less kinetic energy is transferred when accelerating. The surface of the component should be processed as gently as possible.

If the component surface is damaged anyway, the printing parameters of the 3D printer can be adjusted so that the surface of the additive component is more resistant after the printing process.

Advantageously, the use of preferably abrasion-resistant and polyhedral or cylindrical particles PA1 in the depowdering process prevents contamination of the surface from broken blasting agent. Due to the higher breaking strength of the particles PA1, there is little abrasion or breakage when the granules are conveyed through the blasting systems or when the particles PA1 impact the surface of the additively manufactured components, and therefore no contamination on the surface. This means that no particles (fragments) are compacted into the surface of the component in the subsequent compaction process by means of spherical blasting agents.

Likewise, the use of abrasion-resistant and polyhedral or cylindrical particles PA1 in the depowdering process advantageously prevents subsequent processing steps from being adversely affected. Due to the higher breaking strength of the particles, there is almost no abrasion or breakage when the granules are conveyed through the blasting systems or when the particles impact the surface of the additively manufactured components, which is then pressed into the component surface in the subsequent compaction process. The coating, infiltration or coloring is therefore not affected.

In particular, the claimed form of the plastic blasting agent A employed for depowdering does not lead to compaction effects. Because the particles PA1 are lighter than mineral blasting agents, there is less energy input to the surface. This means that the surface of the component remains open-pored and the paint penetration is not affected.

By using the plastic blasting agent A used in the use according to the invention, there is advantageously no uncontrolled breakage due to its material properties. The abrasion that occurs to a small extent here has a finely dispersed grain size (<100 μm/dusty). The grain size and the mass of the dust grains differ so greatly from the uniform grain size of the plastic blasting agent A employed so that it can be easily separated in material separators.

The grain size range of the foreign particles FA1 in the use according to the invention is preferably in a range from 10 μm to 990 μm, particularly preferably in a range from 10 μm to 100 μm and very particularly preferably in a range from 10 μm to 60 μm.

Advantageously, the plastic blasting agent A used here has a uniform grain size. In contrast to common blasting agents, there are no fragments of different grain sizes. In this way, the post-processing effort is reduced to a minimum.

In the use according to the invention, the polymer KA1 is preferably selected from the group consisting of polyamides, resins, polyesters, polystyrenes, polyolefins, polyvinyls, rubbers, polyvinyl chlorides, polyphenylenes, polyethers, polyurethanes, polysaccharides, polyimides, polyacrylates, silicones and blends and copolymers thereof.

In the use according to the invention, the polymer KA1 is preferably selected from the group consisting of polyethylene and copolymers of ethylene, such as HDPE (high density polyethylene), MDPE (medium density polyethylene), LLDPE, VLDPE, LDPE (low density polyethylene), ULDP, ethylene-hexene copolymers, ethylene-octene copolymers, polyisobutylene, ethylene-propylene copolymers (EPM), terpolymers of ethylene-propylene-diene (EPDM), EBM (ethylene butyl rubber), EPDM, ethylene-vinylsilane copolymers, ter- or copolymers of acrylic acid (EA), or ethylene with ethylene acrylate and acrylic acid (EAA) or methacrylic acid (EMA), EEA (ethylene ethyl acrylate), EBA (ethylene butyl acrylate), EVA (ethylene vinyl acetate), graft copolymers of ethylene with maleic anhydride (MAH), polyvinyl chloride (PVC), polyamide 6, polyamide 66, polyamide 12, polyamide 11, polyamide 4, polypropylene and polypropylene copolymers, polyacrylates and polymethacrylates (PMMA), polycarbonate (PC), polybutylene terephthalate (PBT), polyester terephthalate (PET), fluorinated polymeric hydrocarbons, rubber, thermoplastic elastomers (TPE), block copolymers, thermoplastic polyurethanes (TPU) and polyurethanes, thermoplastic polyolefins (TPO), silicone polymers, poly(methyl)methacrylate, polycarbonate, polystyrene, styrene-acrylic nitrile, polyethylene terephthalate, acrylonitrile butadiene styrene (ABS) and a mixture (blend) of the plastics mentioned.

In the use according to the invention, the polymer KA1 is preferably selected from the group consisting of polyethylene, polyamide 6, polyamide 6.6, polyamide 11, polyamide 12, polyamide 4, polyester terephthalate and mixtures thereof, with the foreign particle FA1 being a glass particle with a grain size range in the range from 1 μm to 100 μm, preferably in the range from 3 μm to 70 μm.

In the use according to the invention, the polymer KA1 is particularly preferably selected from the group consisting of polyethylene, polyamide 6, polyamide 6.6, polyamide 11, polyamide 12, polyamide 4, polyester terephthalate and mixtures thereof, with the foreign particle FA1 being a glass bead with a grain size range in the range from 1 μm to 100 μm, preferably in the range from 3 μm to 70 μm.

Due to the often fine structures and geometries that additively manufactured components have, there is usually a requirement to use plastic blasting agents or blasting agents with the smallest possible grain sizes. Only then can it ideally be guaranteed that the accelerated particles can penetrate fine cracks, holes or other structures in the components. This applies to both the depowdering and the compression process. Since the mass of the individual (plastic) particles decreases the smaller they are, they are shot at the components with less energy. In order to increase the energy that is transferred to the component surface with smaller grain sizes, the mass of the particles can be increased by adding denser materials, i. e., by foreign particles. The plastic blasting agent A employed in the depowdering or compacting process therefore preferably processes the component surfaces more effectively despite the smaller grain size. This can preferably be implemented technically in the following ways:
1. Coating or encapsulation of a denser foreign particle (e. g. metals or passivated metals, minerals, glass, iron, steel, ceramics or others) with plastic to yield a particle PA1.
2. Production of plastic granules with several small foreign particles (e. g. metals, passivated metals, minerals, glass, iron, steel, ceramics or others) inside the plastic to yield a particle PA1.
3. Production of plastic granules with several small foreign particles made of different materials (e. g. metals, passivated metals, minerals, glass, iron, steel, ceramics or others) inside the plastic to yield a particle PA1.
4. Production of plastic granules with a large foreign particle (e. g. metals or passivated metals, minerals, glass, iron, steel, ceramics or others) with plastic to yield a particle PA1.
5. Production of a plastic granulate with a combination of a large foreign particle and several small foreign particles (e.g. metals, passivated metals, minerals, glass, iron, steel, ceramics or others) within the plastic, wherein the large particle and the small particles do not have to be made of the same material to yield a particle PA1.

For example, in the depowdering process, preference is given to:
a. Cubic, prismatic or cylindrical, extruded polyamide 6 or polyamide 12 granules admixed with small glass beads during the compounding process.
b. Polyhedral (preferably many-edged, complex-edged) polyamide 6 or polyamide 12 granules admixed with small iron beads during the compounding process.

For example, in the compaction process, preference is given to:
a. An iron or steel ball that has been coated with polystyrene or acrylic
b. A ceramic ball that has been coated with polystyrene or acrylic

### BRIEF DESCRIPTION OF THE FIGURES

In FIG. 1, the depowdering process is illustrated in cross section from the prior art.

In FIG. 2, fragments of a blasting agent from the prior art are illustrated in cross section.

In FIG. 3, the compacting process from the prior art is shown in cross section.

In FIG. 4, another prior art depowdered component is shown in cross section before being colored.

FIG. 5 shows a coloring process from the prior art in cross section.

### DETAILED DESCRIPTION OF THE FIGURES

FIG. 1 illustrates the depowdering process as is known from the prior art. The surface (1) of an additively manufactured component (2) is shown, the surface (1) of which is blasted using a metallic or mineral blasting agent (3) in order to remove powder particles from earlier. This is a known method in the prior art. Fragments (4) of the blasting agent are also shown.

FIG. 2 shows that fragments (4) of the blasting agent used for depowdering are present on the surface (1) of the component (2).

FIG. 3 illustrates the compaction process. This results in the fragments (4) from the first blasting agent entering the surface of the component during the compaction process due to the second blasting agent (5).

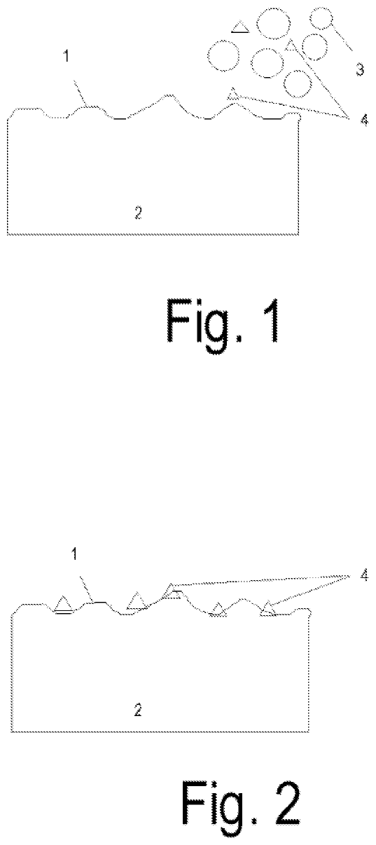

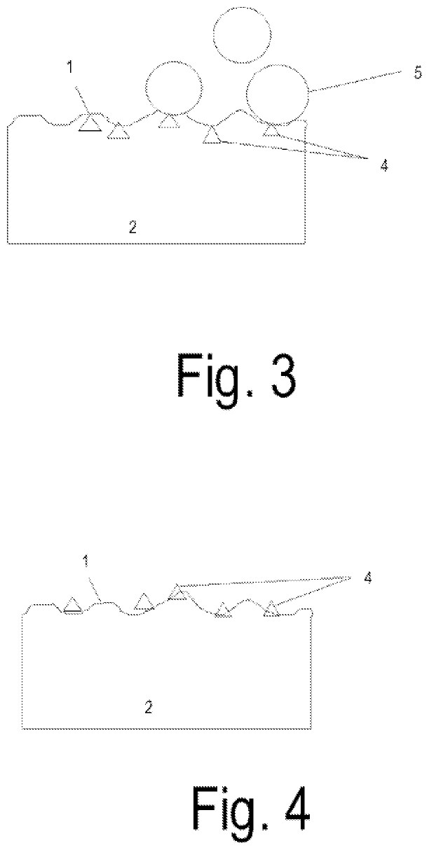

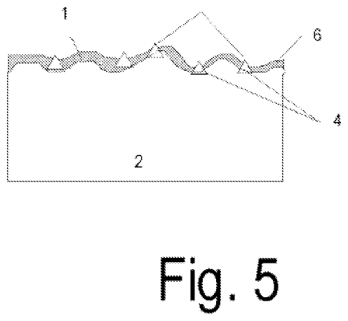

Like FIG. 2, FIG. 4 shows a depowdered component (2) in which the fragments (4) of the blasting agent are present on the surface (2) after the depowdering process. When coloring this component, then, as shown in FIG. 5, the colorant (6) is not applied uniformly to the surface (1) everywhere, since the fragments (4) do not absorb the colorant.

Analytical Methods

Table 1 lists the comparison of the test conditions for determining the various Shore hardness values, as specified in the claims and the description.

TABLE 1
Comparison of the test conditions for determining SHORE hardness values

| Standard | ISO 7619-1 | | EN ISO 868 | | DIN 53606 | | ASTM 2240 | |
|---|---|---|---|---|---|---|---|---|
| Condition | (2012 Feb.) [2] | | (2003 Oct.) [4] | | (2000 Aug.) [1] | | (2015 Aug.) [5] | |
| sample | 6 | mm | 4 | mm | 6 | mm | 6 | mm |
| thickness | | | | | | | | |
| layering | yes (3 layers) | | yes | | yes (3 layers) | | yes | |
| measurements | 5 | | 5 | | 3 | | 5 | |
| measuring | 6 | mm | 6 | mm | 5 | mm | 6 | mm |
| distance | | | | | | | | |

| | | | | | | | |
|---|---|---|---|---|---|---|---|
| holding time | 3 | s vulcanizates | 3 s/15 s | 3 | s | <1 | s |
| | 15 | s TPE | 1 s It. | 15 | s | | |
| | | | specification | | | | |

| | | | | | | |
|---|---|---|---|---|---|---|
| load | 1 | kg SHORE A | A: 12.5N ± 0.5 | A: 12.5N ± 0.5 | 1 | kg |
| | 5 | kg SHORE | D: 50.0N ± 0.5 | D: 50.0N ± 0.5 | | |

D

| | | | | | | |
|---|---|---|---|---|---|---|
| hardness | 54 | Shore A 3 s | A/1: 54 | 54 | Shore A | A/54/15 |
| specification | 54 | Shore A15 s | A/15: 54 | 54 | Shore A 15 s | A/54/1 |

### EXAMPLES

In the examples described below, the treatment of a component with blasting agents is described, comprising two steps.
1. Depowdering of additively manufactured components using the plastic blasting agent described above. (The plastic blasting media employed can also be plastic blasting media with fillings and/or other particles that have been coated with plastic.)
2. Compaction of the component with polystyrene beads.
3. Coloring in the Deep Dye Coloring Process, i. e. coloring in the dipping process or coloring in a colorant solution.

An example of the evaluated process is described below:

1. Depowdering Process

The additively manufactured components were depowdered using a plastic blasting agent.

Properties of the Blasting Agent:
Grain shape: cylindrical
Grain size: uniformly 400 μm
Material properties: Polyamide-6, extruded, filled with glass beads (<100 μm).

Process Parameters:
Blasting time from 5 to 90 minutes
Blasting pressure from 2 to 5 bar
Blow-off pressure (cleaning nozzles) 6 to 8 bar

2. Compaction Process

The depowdered components were then compacted. Polystyrene balls are accelerated in the blasting nozzle of an injector blasting cabin with 5 bar compressed air and blasted onto the component surface. When the spherical polystyrene particles hit the surface, a compaction effect occurs.

Properties of the Blasting Agent:
Grain shape: spherical/ball-shaped
Grain size: Grain size distribution from 400-600 μm
Material properties: polystyrene (polystyrenic copolymer)

Process Parameters:
Blasting time from 5 to 90 minutes
Blasting pressure at 3-5 bar
Blow-off pressure (cleaning nozzles) 6 to 8 bar

3. Coloring/Infiltration Process

The compacted components were then colored using the dipping/infiltration process
Coloring temperature: 115°
Coloring time: Total process approx. 3 hours, depending on material and component quantity, ambient conditions.
Drying time: 30 minutes on average, depending on geometry and component quantity.
Color/color formulation: Varies, especially formulations that are generally particularly problematic.

In combination, the processes meet all requirements. The problems that arise with the commonly utilized glass blasting agent for depowdering do not occur. The color quality on the finished component is significantly better than when using glass blasting agents in the depowdering process.

1. A plastic blasting agent A, comprising at least one particle PA1 made from at least one polymer KA1 and at least one foreign particle FA1, the foreign particle FA1 not being an abrasive grain.

2. The plastic blasting agent A according to claim 1, wherein the polymer KA1 has a Shore hardness of 10 Shore A to 95 Shore D.

3. The plastic blasting agent A according to claim 1, wherein the polymer KA1 is selected from the group consisting of polyamides, resins, polyesters, polystyrenes, polyolefins, polyvinyls, rubbers, polyvinyl chlorides, polyphenylenes, polyethers, polyurethanes, polysaccharides, polyimides, polyacrylates, silicones and blends and copolymers thereof, and the foreign particle FA1 is from the group consisting of metals, passivated metals, iron, steel, minerals, soot particles, carbon fibers, paint particles, ceramics, polymers, alloys or glasses.

4. The plastic blasting agent according to claim 1, wherein the foreign particle FA1 is not of metallic origin.

5. The plastic blasting agent A according to claim 1, wherein the at least one particle PA1 comprises
3 to 95% by weight of at least one polymer KA1,
5 to 97% by weight of at least one foreign particle FA1, and
0 to 10% by weight of at least one additive and/or adhesion promoter.

6. Use of a plastic blasting agent A, comprising at least one particle PA1 made from at least one polymer KA1, and at least one foreign particle FA1 for the surface treatment of a component that was produced by additive manufacturing.

7. Use of a plastic blasting agent A according to claim 6, wherein the component, which was created by means of additive manufacturing, was produced using a method selected from the group consisting of powder bed methods, light-curing methods, or extrusion methods.

8. Use of a plastic blasting agent A according to claim 6, wherein the surface treatment of the component comprises depowdering, compacting, smoothing and/or surface roughening.

9. Use of a plastic blasting agent A according to claim 6, wherein the foreign particle FA1 is not an abrasive grain.

10. Use of a plastic blasting agent A according to claim 6, wherein the polymer KA1 has a Shore hardness of 10 Shore A to 95 Shore D.

11. Use of a plastic blasting agent A according to claim 6, wherein the polymer KA1 is selected from the group consisting of polyamides, resins, polyesters, polystyrenes, polyolefins, polyvinyls, rubbers, polyvinyl chlorides, polyphenylenes, polyethers, polyurethanes, polysaccharides, polyimides, polyacrylates, silicones and blends and copolymers thereof, and the foreign particle FA1 is from the group consisting of metals, passivated metals, iron, steel, minerals, soot particles, carbon fibers, paint particles, ceramics, polymers, alloys or glasses.

12. Use of a plastic blasting agent A according to claim 6, wherein the component is produced by an additive manufacturing or printing method and wherein the component is produced from a material selected from the group consisting of polyamide, thermoplastic polyurethane, aluminum-filled metal, polyamide, glass-filled polyamide, carbon-reinforced polyamide, and combinations, blends, or copolymers thereof.

13. Use of a plastic blasting agent A according to claim 6, wherein the density of the particle PA1 is in a range from 0.7 to 8 g/cm 3.

14. Use of a plastic blasting agent A according to claim 6, comprising at least one particle PA1 made of
3 to 95% by weight of at least one polymer KA1,
5 to 97% by weight of at least one foreign particle FA1, and
0 to 10% by weight of at least one additive and/or adhesion promoter.
